(19) United States
(12) Patent Application Publication
(10) Pub. No.: US 2013/0255583 A1
(43) Pub. Date: Oct. 3, 2013

(54) CONTAINER WITH ANCHORING MECHANISM

(71) Applicants: Tommie T. MILLER SR., Kansas City, MO (US); Marquita L. Miller, Kansas City, MO (US)

(72) Inventors: Tommie T. MILLER SR., Kansas City, MO (US); Marquita L. Miller, Kansas City, MO (US)

(21) Appl. No.: 13/764,965

(22) Filed: Feb. 12, 2013

Related U.S. Application Data
(60) Provisional application No. 61/598,061, filed on Feb. 13, 2012.

(51) Int. Cl. A01K 5/01

(52) U.S. Cl. CPC A01K 5/0135
USPC 119/61.54

(57) ABSTRACT

A food/water bowl for pets that can be secured to the ground. The invention comprises a plastic housing having bilaterally spaced, dual food/water compartments. A stake member is provided for securing the plastic housing to the ground. The stake member may be helical shaped to facilitate insertion of the stake member into the ground and to provide enhanced stability so that the food/water contents do not get wasted from tipping of the container. The stake member and the housing are easily separable for convenience in portability and storage when not needed for feeding the pet.

### RELATED APPLICATIONS

The present U.S. non-provisional patent application is related to and claims priority benefit to an earlier-filed provisional patent application titled TWIST N LOCK DOG BOWL, Ser. No. 61/598,061, filed Feb. 13, 2012. The identified earlier-filed application is hereby incorporated by reference into the present application as though fully set forth herein.

### FIELD OF THE INVENTION

The invention relates to pet food and water containers for placement outdoors.

### BACKGROUND OF THE INVENTION

Many pets, such as dogs, are kept out of doors or are permitted to remain outside for lengths of time. If the length of time in which the pet is kept outdoors is of any appreciable duration, it is necessary to make provisions for their food and water. There exist numerous types of food and water containers for pets that are adapted for outdoor use. Such containers often comprise simple plastic bowls that are merely placed on the ground and filled with food/water as necessary. However, such bowls, typically being lightweight, are susceptible to being carried off or removed from their place. This can happen by an animal carrying off the food bowl or the wind blowing it away. Simple food bowls do not generally have means to secure their position in place on the ground, and so, their contents may be upended and wasted. Also, the bowls may be misplaced or lost.

### SUMMARY OF THE INVENTION

The present invention comprises a food/water bowl for pets that can be secured to the ground. An embodiment of the invention comprises a plastic housing having bilaterally spaced, dual food/water compartments. The housing has a central web portion between the two compartments. A stake member is provided for securing the plastic housing to the ground. The stake member may be helical shaped to facilitate insertion of the stake member into the ground and to provide enhanced stability so that the food/water contents do not get wasted from tipping of the container. Further, by being secured to the ground, the housing is less susceptible to being carried away by an animal. The helical stake member has a handle portion to facilitate turning while inserting the stake member into the ground. The stake member is removably received through the central web portion between the two compartments. The housing can be placed in position on the ground prior to insertion of the stake member. The stake member and the housing are easily separable for convenience in portability and storage when not needed for feeding the pet.

These and other features of the present invention are described in greater detail below in the section titled DETAILED DESCRIPTION OF THE INVENTION.

### BRIEF DESCRIPTION OF THE DRAWING FIGURES

The present invention is described herein with reference to the following drawing figures, with greater emphasis being placed on clarity rather than scale:

FIG. 1 is a top plan view of the housing showing the food/water compartments.

FIG. 2 is a view in side elevation of an embodiment of the stake member.

FIG. 3 is an exploded view of the components of the pet food container assembly.

FIG. 4 is a view in side elevation, partially in cross-section, of the pet food container assembly secured to the ground.

### DETAILED DESCRIPTION OF THE INVENTION

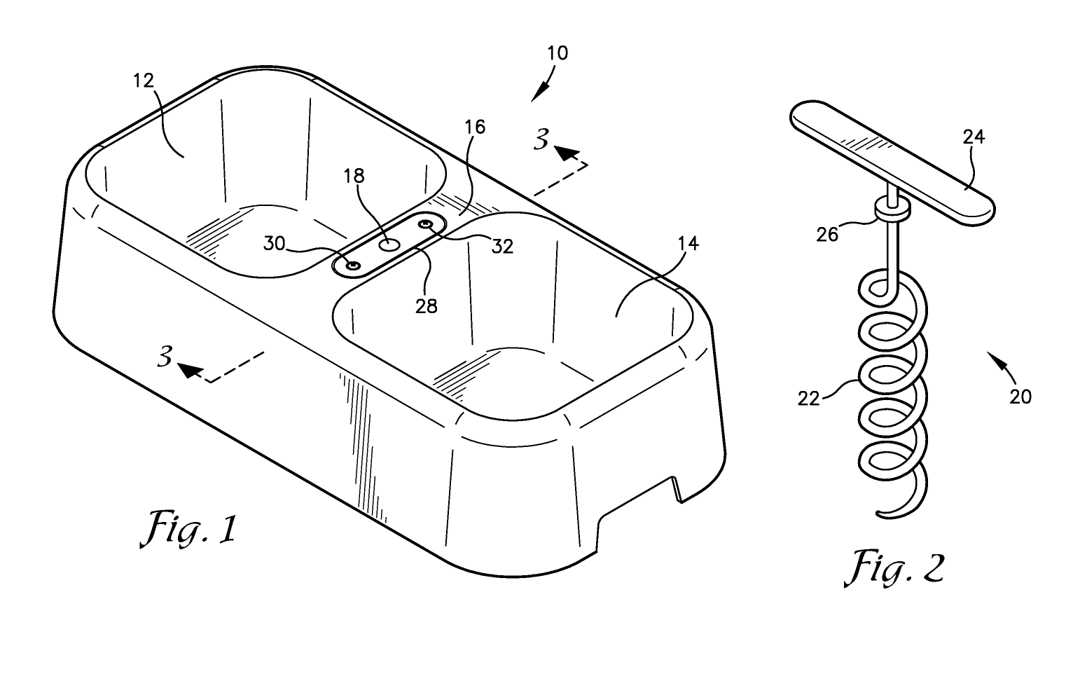

With reference to the drawings figures, a preferred embodiment of the pet food container assembly is herein described, shown, and otherwise disclosed. The pet food container assembly comprises a housing 10 having food/water compartments 12 and 14 disposed in a bilateral configuration as shown in FIG. 1. This configuration is common in pet food/water bowls. Housing 10 may be made of plastic, but other materials, such as rubber or metal, may also be suitable. Web portion 16 lies between compartments 12 and 14. Housing 10 lies generally flat on a surface and is relatively stable.

Stake member 20 enables housing 10 to be secured to the ground. In the context of this invention, the ground is considered to be any of either dirt, sand, gravel or the like. Web portion 16 is provided with an opening 18 for receiving the stake member 20 which is then inserted into the ground. Stake member 20 may have a helical configuration 22 as shown in FIG. 2, although a straight shaft or other stake configuration may be used. A helical-shaped stake provides greater stability in engagement with the ground. Stake member 20 has a handle 24 to enable the user to turn the helical shaft during insertion into the ground. A stop member 26 is spaced distally from and provided below handle 24 to limit the depth to which the stake is inserted through the housing. Stop member 26 should have a greater diameter than opening 18 in housing 10 and may be a simple washer-like element welded to the stake shaft. The helical portion 22 of stake member 20 has a length sufficient to extend beyond the bottom of housing 10 to permit sufficient engagement with the ground. Stop member 26 provides an indicator to the user that the stake member 20 is sufficiently engaged with the ground. The length of stake member 20 will depend on the height of housing 10 which may vary among different pet food containers. In any event, the stake member may be constructed so that its overall length permits passage through the housing up to the stop member 26 and providing for extension of the helical portion a few inches below the bottom of the housing.

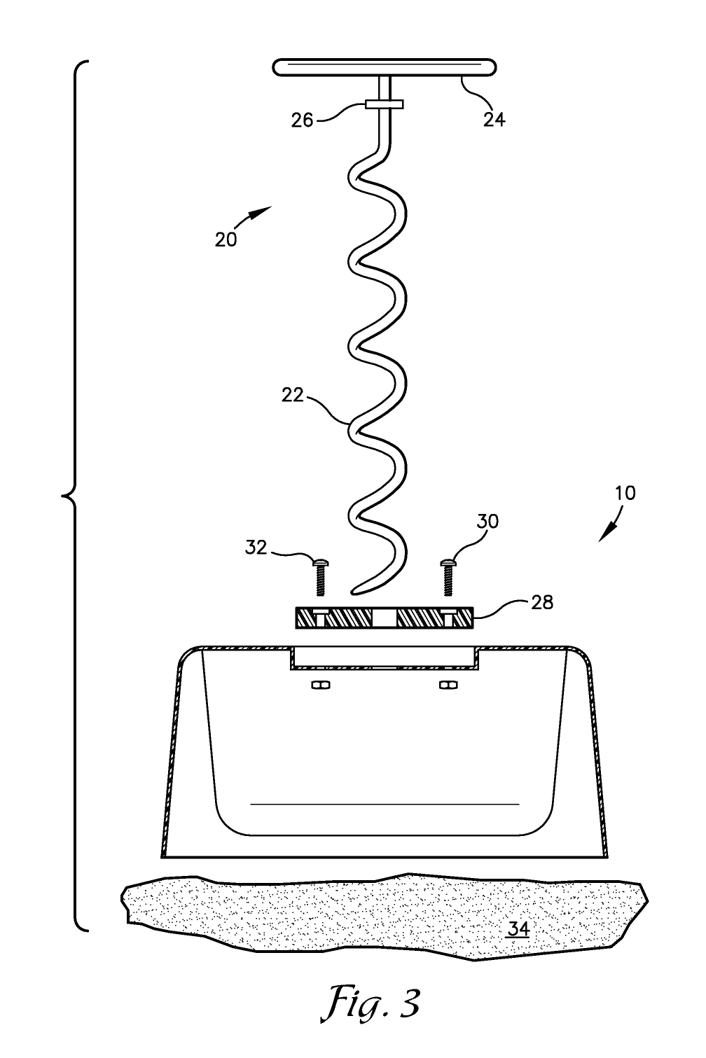

A reinforcing plate 28 is provided at the area of web portion 16 that receives stake member 20. It is provided with an opening for alignment over opening 18 for receiving stake member 20. Reinforcing plate 28 is secured to web portion 26 by fasteners such as bolts 30 and 32 as shown in FIGS. 1 and 3.

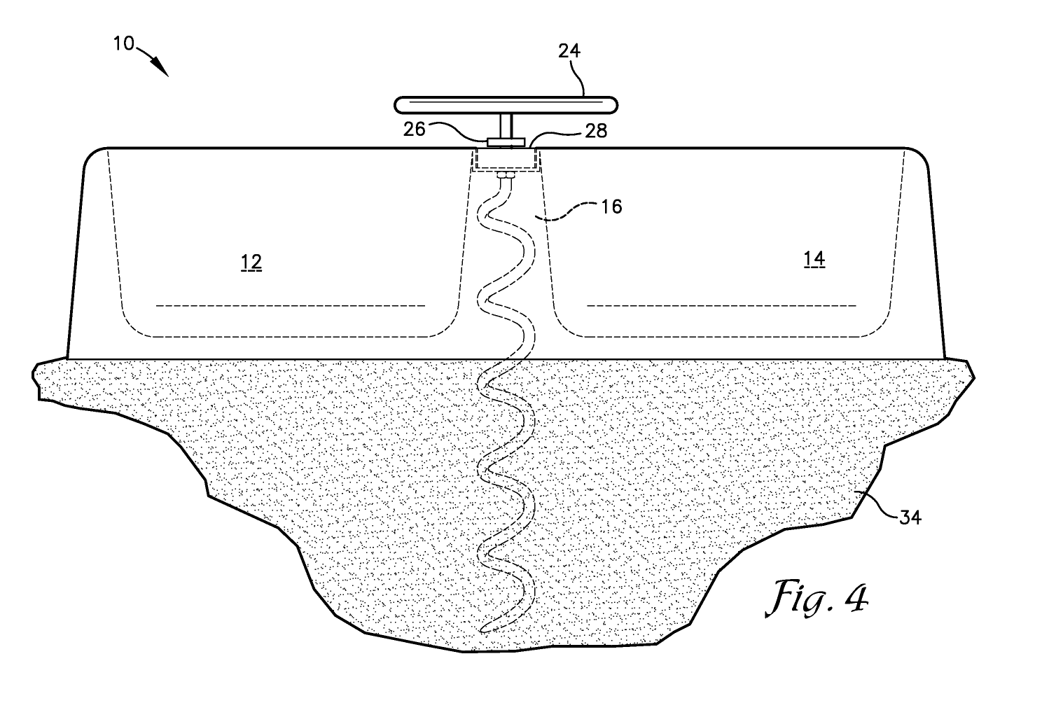

Operation of the food container assembly is very simply accomplished as shown in FIG. 4. Housing 10 is placed on the ground at a desired location. Stake member 20 is inserted through opening 18 in web portion 16, rotating handle 24 to bore into the ground 34. Stop member 26 provides an indicator that the stake is sufficiently inserted into the ground to provide a stable engagement of the housing in place. The housing can be removed from the ground by simply unscrewing the stake. The food container assembly is easily portable and permits quick insertion and removal at any location.

The housing is not limited in configuration to a dual compartment pet bowl. Single compartment bowls, or multi-compartment bowls, may be configured to receive stake member 20 as described above.

Although the invention has been disclosed with reference to a preferred embodiment, it is understood that equivalents may be employed and substitutions made herein without departing from the scope of the invention as recited in the claims.

Having thus described the preferred embodiment of the invention, what is claimed as new and desired to be protected by Letters Patent includes the following:

1. A pet food container assembly for securing to the ground, the assembly comprising:
a) a housing having at least one compartment for receiving food or water, and
b) a stake member,
the housing having a web portion defining an opening for receiving the stake member, the stake member being adapted for insertion into the ground whereby the engagement of the stake member with the ground secures the housing in place.

2. The pet food container assembly of claim 1 in which the stake member comprises a helical element adapted for engagement with the ground.

3. The pet food container assembly of claim 2 in which the stake member has a handle element whereby a user may rotate the stake member to insert it into the ground, the stake member further having a stop member disposed distally from the handle, the stop member having a dimension greater than the opening in the web portion.

4. The pet food container assembly of claim 1 in which the housing comprises two bilateral compartments.

5. The pet food container assembly of claim 4 in which the web portion is disposed between the bilateral components.

6. The pet food container assembly of claim 5 in which the web portion defines fastener openings for receiving fasteners for securing a reinforcing plate member to the web portion, the reinforcing plate member defining an opening for alignment with the opening in the web portion for receiving the stake member.

7. A pet food container assembly for securing to the ground, the assembly comprising:
a) a housing comprising two bilateral compartments for receiving food or water,
b) a reinforcing plate member, and
c) a helical stake member,
the housing having a web portion disposed between the bilateral compartments, the web portion defining an opening for receiving the stake member, the stake member being adapted for insertion into the ground whereby the engagement of the stake member with the ground secures the housing in place, the reinforcing plate being adapted for engagement with the web portion and defining a shaft receiving opening adapted for alignment with the opening in the web portion for receiving the stake member.

8. The pet food container assembly of claim 7 in which the helical stake member has a handle element whereby a user may rotate the stake member to insert it into the ground, the stake member further having a stop member disposed distally from the handle, the stop member having a dimension greater than the opening in the web portion.
